(19) United States
(12) Patent Application Publication
(10) Pub. No.: US 2025/0367723 A1
(43) Pub. Date: Dec. 4, 2025

(54) PROCESS FOR LAYER-BY-LAYER PRODUCTION OF BUILDING STRUCTURES WITH A VISCOSITY-MODIFIED BINDER

(71) Applicant: ASK Chemicals GmbH, Hilden (DE)

(72) Inventors: Heinz Deters, Dusseldorf (DE); Dominik Polsakiewicz, Bonn (DE); Henning Zupan, Haan (DE); Thomas Krey, Dusseldorf (DE); Dennis Bartels, Dorsten (DE); Arkadius Kaminski, Mettmann (DE); Nicolas Riensch, Dusseldorf (DE)

(21) Appl. No.: 18/865,160

(22) PCT Filed: May 12, 2023
(86) PCT No.: PCT/DE2023/100352

§ 371 Date: Nov. 12, 2024

(30) Foreign Application Priority Data
May 13, 2022 (DE) 10 2022 112 109.7

(51) Int. Cl. B22C 1/22; B28B 1/00; B33Y 10/00; B33Y 70/00; B33Y 80/00

(52) U.S. Cl. CPC B22C 1/224; B33Y 70/00; B33Y 80/00; B28B 1/001; B33Y 10/00

(57) ABSTRACT

The subject of the invention is a process for the layer-by-layer production of a building structure using furfuryl alcohol and novolaks as a viscosity modifier, building structures produced in this way, such as cores or molds for metal casting and their use, as well as a binder and a kit comprising binder and, separately therefrom, hardener.

The present invention relates to a process for the layer-by layer production of a three-dimensional building structure. The building structures produced in this way are suitable, among other things, as cores or molds and for metal casting. The building structures produced in this way can also be used for other applications outside of metal casting. The invention also includes a binder and a kit comprising the binder and, separately therefrom, the hardener.

### PRIOR ART

The term molded body refers to cores and molds, individually or together, for metal casting. The molded bodies are essentially made up of cores and molds, which represent the negative molds of the casting to be produced. These cores and molds consist of a refractory material, for example quartz sand, and a suitable binder that gives the molded body sufficient mechanical strength. The refractory molding base material is in a free-flowing form. The binder creates a firm bond between the particles/grains of the molding base material so that the molded body has the required mechanical stability.

Molded bodies must meet various requirements. During the casting process itself, they must first have sufficient strength and temperature resistance to be able to hold the liquid metal in the cavity formed by one or more casting (partial) molds. Once the solidification process has begun, the mechanical stability of the casting is ensured by a solidified metal layer that forms along the walls of the molded body. The material of the molded body must now decompose under the influence of the heat emitted by the metal in such a way that it loses its mechanical strength, i.e. the cohesion between individual particles/grains of the refractory material is broken down. Ideally, the molded body disintegrates back into a fine sand that can be easily removed from the casting.

In addition to metal casting, products from processes with a layer-by-layer construction can also be used for other purposes. Artistic items, such as figurines, and metallic or ceramic products, which are usually transformed into a finished component by a post-treatment step, can be mentioned here as examples, but not exclusively. These products are referred to below as building structures. The term building structure is broader than molded body and includes these and thus also molds and/or cores for metal casting.

The term “3D printing” refers to various methods for producing three-dimensional bodies by building them up through layer-by-layer construction. One advantage of these methods is the ability to produce complex, one-piece bodies with undercuts and cavities. With conventional methods, these bodies would have to be assembled from several individually produced parts. Another advantage is that the processes are able to produce the bodies directly from the CAD data without the need for molding tools.

The 3-dimensional printing processes result in new requirements for binders that hold the building structures/molded bodies together if the binder or a binder component is to be applied through the nozzles of a print head. In this case, the binders must not only lead to a sufficient level of strength and good disintegration properties after metal casting, as well as sufficient thermal and storage stability, but must also be “printable”, i.e. the nozzles of the print head should not be clogged by the binder, and the binder should not be able to flow directly out of the print head, but should form individual droplets.

Various methods are known for the layer-by-layer production of building structures. With the help of these processes, bodies with even the most complicated geometries can be produced directly from the CAD data layer-by-layer using 3D printing and without the need for molding tools. This is not possible with conventional mold-based methods.

WO 01/68336 A2 discloses different binders for the layer-by-layer production. Among other things, the use of an unspecified furan resin with at least 50% furfuryl alcohol and approximately 4% ethylene glycol as a binder component is also mentioned. The resin component of the binder is sprayed layer-by-layer over the entire working surface of a loose molding base material and then cured, also layer-by-layer, but with the selective application of a hardener such as an organic acid. Toluenesulfonic acid is disclosed as an organic acid. The high binder consumption proves to be disadvantageous and costly in this process, since the entire working surface is sprayed with the resin component. WO 01/72502 A1 varies this process in that both liquid binder, also including a furan resin not described in more detail, and liquid hardener such as toluenesulfonic acid are applied successively in the sequence resin component and then hardener selectively and layer by layer to the partial areas to be hardened.

A further process for the layer-by-layer production of cured three-dimensional molded articles is disclosed in WO 2018/224093 A1. In this publication, a resin component comprising a furan resin as a reaction product of at least aldehyde compound and furfuryl alcohol and optionally compounds containing nitrogen and/or phenol compounds, wherein the nitrogen content of the resin component is less than 5 wt. % and wherein the resin component contains more than 5 wt. % and less than 50 wt. % of monomeric furfuryl alcohol, based on the resin component, is used.

In WO 2004/110719 A2, the order of addition is reversed. First, the molding base material is premixed with a hardener and then the resin component is selectively applied layer-by-layer. Acids, amines and esters are mentioned as hardeners. The hardeners are not described in detail. The resin component is described as having a viscosity of 5 mPas to 60 mPas at 20° C.

DE 102014106178 A1 describes a process for layer-by-layer production of bodies, in which a molding base material is cured layer by layer using a resol resin and an ester.

In particular, the acid/furan resin system according to WO 2004/110719 A2 and the ester/resol resin system according to DE 102014106178 A1 have found some widespread use in the layer-by-layer production of molded bodies in practice and are used in the development of new castings and in the production of individual parts or small series where conventional production with molding tools would be too complex and expensive or only feasible with a complicated core package.

The disadvantage of the acid/furan resin system is that the application of the binder using an inkjet print head can be severely impaired if the viscosity of the binder is too low. This can lead to uncontrolled leakage of the binder from the print head or uncontrolled droplet generation via the print head. This applies in particular to binders with a high proportion of monomeric furfuryl alcohol. In addition, the viscosity of the binder can vary greatly depending on a changed process temperature, as described, for example, in WO 2004/110719 A2.

### OBJECT OF THE INVENTION

It is therefore the object of the present invention to provide a process for the layered production of a three-dimensional molded body or building structure, in which the binder used enables optimum application due to adapted viscosity, e.g. via an inkjet print head. Furthermore, the molded body or building structure should have good strength.

### SUMMARY OF THE INVENTION

The problem is solved by a process with the features of the independent claims. Advantageous further developments of the process according to the invention are the subject of the dependent claims or are described below.

The invention relates to a process for the layer-by-layer production of building structures from a building material mixture comprising at least a building base material, a hardener and a binder, comprising at least the following steps:
a) providing at least a building base material, a hardener and a binder;
b) spreading a layer (thin layer) of at least the building base material with a layer thickness of 0.05 mm to 3 mm, preferably 0.1 mm to 2 mm and particularly preferably 0.1 to 1 mm;
c) printing selected areas of the layer with the binder comprising at least furfuryl alcohol and a viscosity modifier; and
d) repeating steps b) and c) several times;
wherein the hardener is either spread in the substrate as part of the layer or applied to the layer, or both; and
where the hardener is or contains an acid;
wherein the viscosity modifier is a novolak dissolved in the binder and
the binder has a viscosity of 5 to 40 mPas at 25° C.

The building material mixture comprises at least the building base material, the hardener and the binder.

The hardener can be incorporated into the building base material or applied to the layer, e.g. to every second or third layer. Typically, hardener is then applied to each layer. The hardener can be applied using a spray or pressure head, for example. The proportion of hardener is preferably 0.05 wt. % to less than 3 wt. % of hardener, based on the building material mixture.

The binder contains furfuryl alcohol and the viscosity modifier dissolved in it (obligatory components) and possibly other optional components.

According to one embodiment, the proportion of furfuryl alcohol in the binder as a whole is more than 60 wt. %, preferably more than 75 wt. %, particularly preferably more than 80 wt. %, and very particularly preferably more than 90 wt. %. According to one embodiment, apart from the novolak, no other resins are used in the binder.

The binder has a viscosity of 5 to 40 mPas at 25° C. The viscosity modifier is a novolak. The novolak preferably has a number-average molecular weight of greater than 300 g/mol.

The binder comprises in particular 0.1 to 25 wt. % or 0.1 to 12 wt. %, preferably 2.0 to 9.0 wt. %, and particularly preferably 3.0 wt. % to 8.0 wt. % of the novolak.

It was found that the viscosity modifier has good solubility in the binder. In particular, the novolak is added in solid form and then dissolved in the binder. To accelerate the dissolution, the dissolution is preferably carried out by heating to above 30° C.

According to one embodiment, the building material mixture does not contain any formaldehyde donors such as hexamethylenetetramine, because the hardening takes place by hardening the furfuryl alcohol by means of acids and not by the reaction of hexamethylenetetramine and the novolak.

In addition to the furfuryl alcohol and the viscosity modifier, the binder may contain optional components. The total of the optional components in the binder is preferably less than 39.9 wt. %, based on the total of the binder, in particular preferably less than 20 wt. % based on the total of the binder, and particularly preferably less than 15 wt. %, or even less than 10 wt. % based on the total of the binder. The optional components must be dissolved in the binder. The proportions add up to 100 wt. % in each case.

The binder is selectively applied to the spread thin layer comprising at least the building base material and, for example, possibly building and molding base additive(s) or possibly the hardener, by means of a printing device.

The binder is the furfuryl alcohol with a viscosity modifier dissolved in it, as well as any optional components optionally dissolved in it. The hardener is not part of the binder. In addition to the binder, the binder system also comprises at least the hardener. The binder is printed as a uniform printing fluid using the nozzles of the print head.

Furthermore, the invention relates to a building structure, in particular a molded body, producible by the process according to the invention. The building structure can be used in numerous applications and is not further limited in its intended use.

Furthermore, the invention relates to a molded body which can be produced by the process according to the invention. The molded body is used or intended for metal casting, in particular iron, steel, copper or aluminum casting.

If the building material mixture is used for the production of moldings, it can also be referred to as a molding material mixture and the building base material analogously as a molding base material.

It was observed that the viscosity modifier caused a reduction in the strength of molded parts produced by hand molding in the NoBake process (hereinafter referred to as the standard NoBake process), compared to binders that had the same structure but lacked the viscosity modifier.

Surprisingly, it was found as an object of the present invention that the binder according to the invention leads to significantly higher strengths in the 3D procedure compared to binders with the same structure, apart from the viscosity modifier.

In addition, the binder according to the invention (containing the viscosity modifier) proves to be very stable in storage, has good compatibility and—compared to binders of the same composition, apart from the viscosity modifier-shows good pressure stability.

Further claimed is a kit comprising the binder and separately therefrom the hardener comprising an acid.

### DETAILED DESCRIPTION OF THE INVENTION

The components of the process are described in more detail below:

### Building Base Material

The subsoil is an inorganic material that is present in particulate form. The building base material is not particularly limited. According to another embodiment, the building base material is a silicon carbide or possibly another sinterable material. In this case, a building structure is produced which is later sintered.

According to another preferred embodiment, the building base material is a refractory molding base material (in particular when used to produce a molding material mixture).

The refractory molding base material is not particularly limited. All particulate solids can be used as refractory molding base materials/building base materials. The refractory molding base material preferably has a free-flowing state. Common and known materials in pure form as well as mixtures thereof can be used as refractory molding base material for the production of molded bodies. Suitable materials include, for example, quartz sand, zircon sand or chrome ore sand, olivine, vermiculite, bauxite, fireclay, as well as artificially produced refractory molding base materials or those available from synthetic materials, such as glass beads, glass granulate, hollow aluminum silicate microspheres and mixtures thereof. For cost reasons, quartz sand is particularly preferred. Therefore, the refractory molding base material preferably consists of more than 90 wt. % of quartz sand.

A refractory molding base material is understood to be a material that has a high melting point (melting temperature). Preferably, the melting point of the refractory molding base material is at least about 600° C., preferably at least about 900° C., particularly preferably at least about 1200° C., and especially preferably at least about 1500° C.

The average particle diameter of the refractory molding base material is usually from about 30 μm to about 500 μm, preferably from about 40 μm to about 400 μm, and particularly preferably from about 50 μm to about 250 μm. The particle size can be determined, for example, by sieving according to DIN ISO 3310. The proportion of the building base material or refractory molding base material in the building material mixture is not particularly limited. The building base material or refractory molding base preferably makes up at least about 80 wt. %, in particular at least about 90 wt. %, especially preferably at least about 93 wt. % of the building material mixture or molding material mixture.

### Building- and Molding Base Material Additives

The building material mixture can contain other solids in addition to the building base material/the refractory molding base material. In the context of the invention, these are referred to as building or molding base additive(s). They are usually particulate solids. The average particle diameter of the building and molding base additives is generally from about 30 μm to about 500 μm, preferably from about 40 μm to about 400 μm, and particularly preferably from about 50 μm to about 250 μm. The particle size can be determined, for example, by sieving according to DIN ISO 3310.

The building base material or refractory molding base material, hardener and binder and the optional building or molding base material additives (if present) are referred to as the building material mixture. Examples of building or molding base additives are organic or mineral additives such as iron oxides, silicates, aluminates, wood flours or starches as well as mixtures thereof. These can be added to the refractory molding base material to prevent casting defects.

The amount of the building or molding base additive is not particularly limited and is usually at most about 10 wt. %, preferably at most about 7 wt. %, and particularly preferably at most about 1 wt. % based on the building or molding base mixture.

In a preferred embodiment, amorphous SiO₂ is used as a building- or molding base material additive.

The construction and molding base additives are applied in a distributed manner to the thin layer. There is no selective application of the construction or molding base additives.

### Hardener

The hardener is or contains an acid. In the hardener for curing the binder, conventional acids for foundry mold production or mixtures thereof with a pKₛ value at 25° C. of less than 4, preferably with a pKₛ value of less than or equal to 3.9, preferably with a pKₛ value of less than 3 and particularly preferably with a pKₛ value of less than 1.5 (in each case at 25° C.) are used, such as organic acids such as para-toluenesulfonic acid, xylenesulfonic acid, benzenesulfonic acid, methanesulfonic acid or lactic acid as well as inorganic acids such as sulfuric acid or phosphoric acid or mixtures of various organic and inorganic acids. The hardener may also contain water. Particularly preferred hardeners are aqueous para-toluenesulfonic acid, sulfuric acid and/or lactic acid as well as mixtures thereof.

The amount of hardener, including any optional aqueous dilution, in the building material mixture/molding material mixture is in particular 0.05 wt. % to 3 wt. %, preferably 0.1 wt. % to 2.5 wt. %, and particularly preferably 0.1 wt. % to 2 wt. %, based in each case on the building or molding material mixture.

Furthermore, the hardener may contain additives, in particular to optimize the sand properties. These include, for example, hardening moderators such as glycols, particularly ethylene glycol or alcohols such as ethanol, which are used in quantities of 0 wt. % to 15 wt. %, preferably from 0 wt. % to 10 wt. %, and in particular from 0 wt. % to 7 wt. %, based on the hardener.

The hardeners can also be selectively applied to the thin layer of the building material mixture in an additional process step. The selective application of the hardener can be carried out using additional integrated application mechanisms, for example an inkjet print head or a spraying device.

In a preferred embodiment, the hardener is added/mixed into the building material mixture before the thin layer is spread and is not applied selectively.

### Binder

The binder contains furfuryl alcohol. The proportion of furfuryl alcohol in the binder as a whole is in particular more than 60 wt. %, preferably more than 75 wt. %, particularly preferably more than 80 wt. %, and very particularly preferably greater than or equal to 88 wt. % or more than 90 wt. %. According to one embodiment, apart from the novolak, no other resins are used in the binder.

The binder has a viscosity of 5 to 40 mPas, preferably of 6 to 30 mPas, particularly preferably of 7 to 20 mPas, and most preferably of 8 to 13 mPas, in each case at 25° C. The viscosity is measured on a Brookfield rotational viscometer with the measuring geometry spindle 18 at a viscosity of up to 16 mPas and a speed of 200 rpm and at a viscosity of less than 16 mPas with the measuring geometry spindle UL adapter at a speed of 50 rpm. Unless otherwise stated, the viscosity was determined at 25° C. in each case.

The binder preferably has a surface tension of 15 to 65 mN/m, preferably of 20 to 50 mN/m, particularly preferably of 25 to 45 mN/m, and very particularly preferably of 30 to 40 mN/m. The surface tension is measured using the ring method according to DeNoüy (at 25° C.).

The binder preferably has a density of 1.0 to 1.5 g/cm³, particularly preferably from 1.05 to 1.4 g/cm³, particularly preferably from 1.05 to 1.2 g/cm³, and most preferably from 1.1 to 1.2 g/cm³. The density is measured using the oscillating U-tube method at 20° C.

The binder preferably has a pH value of 3 to 9, preferably a pH value of 4 to 8, particularly preferably a pH value of 5 to 7.5, and very particularly a pH value of 6 to 7.5.

The amount of binder is preferably from 0.1 wt. % to 10 wt. %, preferably from 0.5 wt. % to 7.5 wt. %, and particularly from 0.8 wt. % to 4 wt. %, based in each case on the building or molding material mixture.

### Viscosity Modifier

The binder contains a novolak to adjust the viscosity. Novolaks are storage-stable methylene-bridged phenolic resins with an aldehyde to phenol ratio or formaldehyde to phenol ratio of less than 1 to 1, which are produced by polycondensation of the reactants in the presence of catalytic amounts of an acid or a metal salt. Preferably, an acidic condensation is carried out, i.e. an acid is preferably used.

In general, the aldehyde to phenol ratio in novolaks is from 0.3:1 to less than 1:1, preferably 0.4 to 0.9:1 and particularly preferably 0.6:1 to 0.9:1.

Phenols, such as phenol and/or substituted phenols, are suitable monomers for the production of novolaks. In addition to phenol, cresols or nonylphenol, examples are 1,2-dihydroxybenzene (pyrocatechol), 1,3-dihydroxybenzene (resorcinol) or 1,4-dihydroxybenzene (hydroquinone) and/or substituted phenols, such as cashew nut shell oil, i.e. a mixture of cardanol and cardol, bisphenol A, bisphenol F, bisphenol S or mixtures thereof. Phenol is particularly preferred, e.g. based on the molar amount of phenols incorporated in the novolaks, e.g. greater than 90 mol % phenol or even greater than 95 mol % phenol.

Suitable aldehydes are, for example, formaldehyde, e.g. in the form of aqueous solutions or as a polymer in the form of paraformaldehyde, butyraldehyde, glyoxal and mixtures thereof. Particularly preferred is formaldehyde or mixtures containing predominantly (based on molar amount of aldehydes, e.g. greater than 90 mol % formaldehyde or even greater than 95 mol % formaldehyde.

Acids such as hydrochloric acid, sulphuric acid, phosphoric acid, sulphonic acids, oxalic acid or salicylic acid or anhydrides such as maleic anhydride are used as catalysts to produce the novolaks. Oxalic acid is preferably used. Another possibility is the addition of a metal salt, e.g. based on Zn(II), Mg(II) or Cu(II) salts in catalytic quantities, e.g. as acetate.

Typical for novolaks is the following structural unit with methylene bridges, wherein the predominant ortho-ortho linkage is only one of the possible linkages, albeit a preferred one. Some, but preferably few, of the phenol groups (e.g. less than 10 mol %) may also be substituted or have further hydroxy groups.

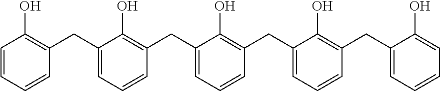

The novolaks used can basically take any form, such as powder, flakes or pastilles. They are preferably used in powder form (at 25° C.) and then dissolved in the binder or furfuryl alcohol.

The free phenol content of the novolak used is in particular less than 5.0 wt. %, more preferably less than 1.0 wt. %, even more preferably less than 0.5 wt. % and most preferably less than 0.2 wt. %. The free phenol content is measured by gas chromatography (GC) according to DIN 16916-02-L2/DIN EN ISO 8974.

The amount of viscosity modifier is 0.1 wt. % to 12.0 wt. %, preferably 2.0 wt. % to 9.0 wt. %, and most preferably 3.0 wt. % to 8.0 wt. %, based on the binder as a whole.

The number average molecular weight of the viscosity modifier is in particular more than 300 g/mol, preferably more than 500 g/mol, and particularly preferably more than 600 g/mol. The number average molecular weight of the viscosity modifier is in particular more than 500 g/mol, preferably more than 1500 g/mol, particularly preferably more than 2500 g/mol and very particularly preferably more than 3500 g/mol. The molar mass (number average) of the viscosity modifier is preferably less than 50,000 g/mol, preferably less than 25,000 g/mol. The molecular weight is measured by gel permeation chromatography (GPC) in THF according to DIN 55672-1.

The novolaks used may contain hexamethylenetetramine. It is particularly preferred that the novolak is used in the absence of hexamethylenetetramine, i.e. the hexamethylenetetramine is neither added to the building base material nor to the binder.

The production of novolaks has been known to the skilled person for a long time and is described in detail, for example, by L. Pilato in his book “Phenolic Resins: A century of Progress”, published in 2010 by Springer Verlag in chapters 4 and 7, in particular 4.3.1 to 4.3.4.

### Optional Components of the Binder

The binder may contain other optional components such as other resins (different from Novolak), water, glycol, alcohol, phenolic compounds, solvents, silanes, plasticizers, curing modifiers, surface modifiers or surface-active substances.

The binder may further contain phenol, phenol compounds, resins, water, glycols, alcohols, solvents and/or silanes, in particular individually and/or in the sum of 0.01 to 15 wt. %, preferably 2 to less than 12 wt. %, and particularly preferably 5 to less than 10 wt. %, based on the binder.

Optionally, phenolic compounds can be included in the binder to increase the sand's technical properties, for example its strength. The phenol compounds are phenols and substituted phenols. Phenols are characterized by one or more aromatic rings and at least one hydroxy substitution on these. In addition to phenol itself, examples include phenols such as cresols or nonylphenol, 1,2-dihydroxybenzene (pyrocatechol) or 1,3-dihydroxybenzene (resorcinol). e.g. cashew nut shell oil, i.e. a mixture of cardanol and cardol, 1,4-dihydroxybenzene (hydroquinone), bisphenol A, bisphenol S or bisphenol F or mixtures thereof. Particularly preferred is resorcinol as a phenol compound. Substituted phenols are phenols substituted with hydrocarbon groups and/or bridged via hydrocarbons. Phenolic compounds as an optional component are thus compounds that fall into the group of phenols or substituted phenols. A novolak or another polymer containing phenol as a monomer component is/are not a phenol compound within the meaning of the invention.

As an optional component, the binder preferably contains silanes comprising silicon —O—(C1- to C4-alkyl) groups and possibly also silicon —(C1- to C4-alkyl) and/or —(C1- to C4-alkylene)-amino) groups. A preferred representative of these is aminopropyltriethoxysilane.

The binder may also optionally contain other resins (different from novolak) which are dissolved in the furfuryl alcohol of the binder. If a further resin is added to the binder, this resin preferably comprises a furan resin. The furan resin is not particularly limited and may be any furan resin known in the art.

For example, the furan resin can be a polymer of furfuryl alcohol and/or furan, but also a polymer which—in addition to furfuryl alcohol and/or furan—contains formaldehyde, urea and/or phenol as a further monomer or further monomers.

The proportion of the optional further resins, in particular the furan resins, in the total binder is less than 15 wt. %, preferably less than 12 wt. %, and particularly preferably less than 10 wt. %, in particular greater than 2 wt. %, and in particular greater than 5 wt. %.

The proportion of the optional components in the binder as a whole is less than 39.9 wt. %, or preferably less than 20 wt. %, or less than 15 wt. %, and particularly preferably less than 10 wt. %.

If no resins are used as optional components, the proportion of resins used as optional components is preferably less than 20 wt. %, or less than 15 wt. %, and particularly preferably less than 10 wt. %.

### Process

As soon as the strengths allow, the unbound building material mixture (where the binder has not been applied or, if the hardener is also applied selectively, even without the hardener) can then be removed from the building structure and the building structure can be subjected to further treatment, e.g. preparation for metal casting. The unbonded building material mixture can be removed from the bound building material mixture, for example, by means of a spout so that the unbound building material mixture can trickle out.

The bonded building material mixture (building structure) can be freed from residues of the unbound building material mixture using compressed air or by brushing, for example.

The unboned building material mixture can be reused for a new printing process.

Printing is carried out, for example, using a print head with a large number of nozzles, with the nozzles preferably being individually selectively controllable. According to a further embodiment, the print head is moved by a computer in at least one plane and the nozzles apply the liquid binder layer-by-layer. The print head can, for example, be a drop-on-demand print head with bubble jet or preferably piezo technology.

### EXAMPLES

The invention is explained below with reference to experimental examples, but is not limited to these.

Unless otherwise stated, all ratios and percentages refer to the weight.

### Example 1: Strengths of Produced Building Structures in the Standard NoBake Process

In order to compare the strength development of different binders, quartz sand H32 from the Quarzwerke Group Haltern was placed in a wing mixer from Beba. Then 1.0 wt. % of the binder in relation to the sand and then 0.4 wt. % of a sulphonic acid-based hardener in relation to the sand were added and mixed intensively with the building base material for 1 minute each (mix 1).

A commercial product (greater than 87 wt. % furfuryl alcohol and bisphenol-A and less than 0.5 wt. % silane) with a viscosity of 9 mPas at 25° C. was used as comparative binder 1 (V).

Binder 2 (greater than 87 wt. % furfuryl alcohol), prepared with the addition of 6.5 wt. % of a novolak as a viscosity modifier, was also adjusted to 9 mPas at 25° C. Both binders contain the same type and the same amount of silane as an optional component.

The Novolak had a number average molecular weight of 697 g/mol. The molecular weight was determined using a GPC chromatogram generated on an Agilent 1100 series instrument equipped with an 8×50 mm SDV precolumn, a linear SDV column (5 μm, 1000 Å) and a linear SDV column (5 μm, 100 Å). The respective sample was measured with a flow rate of 1 mL min 1 in THF and polystyrene 700000 as internal standard at 35° C., calibrated against polystyrene standards. Detection was carried out using the UV signal (271 nm). Alternatively, detection via the refractive index (RI) is also possible. Detection via the UV signal (271 nm) is preferred. The chromatograms were analyzed using WinGPC software. SDV stands for divinylbenzene cross-linked polystyrene.

The following samples were used:
Binder 1 (V): Furfuryl alcohol plus bisphenol-A and silane (viscosity: 9 mPas at 25° C.)
Binder 2: Furfuryl alcohol plus Novolak as viscosity modifier and silane: 6.5% Novolak (viscosity: 9 mPas at 25° C.)

For the strength test, rectangular test bars with the dimensions 171 mm×22.36 mm×22.36 mm were produced (Georg Fischer bars). For this purpose, a part of the produced molding material mixture was filled into a molding box with 12 engravings in the above-mentioned dimensions and compacted by vibration for 30 seconds. After 30 minutes, the test bars were removed from the engravings in the molding box.

The strength was tested by determining the 3-point flexural strength on the Jung SJ1 strength testing machine from Jung Instruments.

The flexural strengths were determined after the following times:
1 hour after molding
2 hours after molding
4 hours after molding
24 hours after molding

The strengths obtained are summarized in Table 1.

TABLE 1
Strengths for different binders after
1, 2, 4 and 24 hours (V: comparison).

| | |
|---|---|
| Molding compound | Flexural strength [N/cm²] |

| containing | 1 hr. | 2 hrs. | 4 hrs. | 24 hrs. |
|---|---|---|---|---|
| Binder 1(V) | 372 | 472 | 519 | 554 |
| Binder 2 | 289 | 417 | 496 | 503 |

In the standard NoBake process, a reduction in strength is observed due to the addition of Novolak.

### Example 2: Strengths of Produced Building Structures in 3D Printing

In order to compare the strength development of different binders in a 3D printing procedure, a precursor of quartz sand GS 14 (average grain size 0.14 mm, product of the Strobel company) was first presented and mixed with 0.20 wt. % of a sulfonic acid-based hardener, based on the sand, in a wing mixer to produce the molding material mixture 2. The hardener was para-toluenesulfonic acid 65 wt. % in water.

The building structures were produced on a commercial printing system (VX 200 from Voxeljet AG with a piezo inkjet print head). The preliminary stage of the building material mixture was spread layer-by-layer of 0.28 mm thickness using a vibration-supported application process in the printer's build chamber and smoothed using a metal blade. In the next step, the binder was selectively applied according to the CAD data provided. Bending bars with the dimensions 22.36 mm×22.36 mm×170.00 mm were produced as building structures. The amount of binder added was always set to 1.85 vol. %, based on the volume of the building material mixture. The strength and loss on ignition at 900° C. and a holding time of 3 h were tested after 12 h.

A binder (greater than 87 wt. % furfuryl alcohol plus bisphenol-A and less than 0.5 wt. % silane) with a viscosity of 9 mPas at 25° C. was used as comparative binder 1 (V).

The printing performance depends on the viscosity. For this reason, binder 2 (greater than 87 wt. % furfuryl alcohol) was also adjusted to 9 mPas by adding 6.5 wt. % of a novolak as a viscosity modifier. Both binders contain the same type and the same amount of silane as an optional component.

The following samples were produced:
Binder 1 (V): Furfuryl alcohol plus bisphenol-A and silane (viscosity: 9 mPas at 25° C.)
Binder 2: Furfuryl alcohol plus Novolak as viscosity modifier and silane: 6.5% Novolak (viscosity: 9 mPas at 25° C.)

The strength was tested by determining the 3-point flexural strength on the Jung SJ1 strength testing machine from the company Jung Instruments. The strengths and ignition losses obtained are shown in Table 2 listed.

TABLE 2
Strength and loss on ignition for different binders with
adjusted viscosity, as well as corresponding loss on ignition
at 900° C. and 3 h holding time (V: comparison)

| | | Loss on ignition at |
|---|---|---|
| Building material | Strength after 12 | 900° C. and 3 h holding |
| mixture with | h [N/cm]² | time [%] |
| Binder 1 (V) | 245 | 1.7 |
| Binder 2 | 361 | 1.7 |

The ignition losses showed that both building structures contained the same amount of binder. The tested building material mixtures are therefore comparable.

Surprisingly, binder 2 was found to have a significantly higher strength in 3D printing compared to binder 1 (V). Surprisingly, it was found that the binde according to the invention leads to significantly higher strengths in the 3D proce compared to binders with the same structure, apart from the viscosity modifier, which could not be derived from the strengths in the standard NoBake procedure (compare example 1), because there the addition of Novolak to the binder was associated with a loss of strength there.

1. A process for the layer-by-layer production of building structures from a building material mixture comprising at least a building base material, a hardener and a binder, comprising at least the following steps:
a) providing at least a building base material, a hardener and a binder;
b) spreading a layer of at least the building base material with a layer thickness of 0.05 mm to 3 mm;
c) printing selected areas of the layer with the binder comprising at least furfuryl alcohol and a viscosity modifier; and
d) repeating steps b) and c) several times;
wherein the hardener is either spread as part of the layer in the building base material or is applied to the layer, or both;
wherein the hardener is or contains an acid;
wherein the viscosity modifier is a novolak dissolved in the binder;
wherein the binder has a viscosity of 5 to 40 mPas at 25° C.;
wherein the binder comprises from 0.1 to 25 wt. % by weight of the novolak; and
wherein the binder comprises more than 60 wt. % by weight furfuryl alcohol.

2. The process according to claim 1, wherein the binder comprises more than 75 wt. %, preferably more than 80 wt. %, and particularly preferably more than 90 wt. % of furfuryl alcohol.

3. The process according to claim 1, wherein the binder comprises 0.1 to 12 wt. %, preferably 2.0 to 9.0 wt. %, and more preferably 3.0 wt. % to 8.0 wt. % of the novolak.

4. The process according to claim 1, wherein the novolak is added in solid form to the furfuryl alcohol or the binder and is then dissolved in the binder.

5. The process according to claim 1, wherein the number average molecular weight of the viscosity modifier is greater than 300 g/mol, preferably greater than 500 g/mol, and particularly preferably greater than 600 g/mol.

6. The process according to claim 1, wherein the free phenol content of the novolak is less than 5.0 wt. %, preferably less than 1.0 wt. %, still more preferably less than 0.5 wt. % and very particularly preferably less than 0.2 wt. %.

7. The process according to claim 1, wherein the binder has a viscosity of from 6 to 30 mPas, particularly preferably from 7 to 20 mPas, and very particularly preferably from 8 to 13 mPas, in each case at 25° C.

8. The process according to claim 1, wherein between 0.05 wt. % and less than 3 wt. %, preferably between 0.1 wt. % and 2.5 wt. %, and particularly preferably between 0.1 wt. % and 2 wt. % of hardener, based in each case on the building material mixture, are used.

9. The process according to claim 1, wherein the hardener further comprises glycols, in particular ethylene glycol, and/or alcohols, in particular ethanol, preferably in amounts of greater than 0 wt. % to 15 wt. %, based on the hardener.

10. The process according to claim 1, wherein the binder further comprises phenol, phenol compounds, further resins, water, glycols, alcohols, solvents and/or silanes, in particular in the sum of from 0.01 to 15 wt. %, preferably from 2 to less than 12 wt. %, and particularly preferably from 5 to less than 10 wt. %, based on the binder.

11. The process according to claim 1, wherein the binder comprises less than 15 wt. %, preferably less than 12 wt. %, and particularly preferably less than 10 wt. % of furan resins.

12. The process according to claim 1, wherein the building material mixture comprises a building base material, preferably a refractory molding base material, and the refractory molding base material preferably comprises quartz sand, zircon sand, chrome ore sand, olivine, vermiculite, bauxite, chamotte, glass beads, glass granulate, aluminum silicate micro hollow spheres and mixtures thereof.

13. The process according to claim 1, wherein the building base material has average particle diameters of from 30 μm to 500 μm, preferably from 40 μm to about 400 μm, and particularly preferably from 50 μm to about 250 μm, determined by sieving according to standard DIN ISO 3310.

14. The process according to claim 1, wherein greater than 80 wt. %, preferably greater than 90 wt. %, and particularly preferably greater than 93 wt. % of the building material mixture is refractory molding base material.

15. The process according to claim 1, wherein the building material mixture further comprises amorphous silicon dioxide, in particular 1 to 10 wt. %.

16. The process according to claim 1, further comprising the following steps:
i) hardening of the building structure after completion of the layer-by-layer construction, optionally in an oven or by means of a microwave, to obtain an at least partially hardened building structure;
ii) of subsequently removing the unbound building material mixture from the at least partially hardened building structure.

17. The process according to claim 1, wherein the printing is carried out with a print head having a plurality of nozzles, wherein the nozzles are preferably individually selectively controllable, wherein the print head is in particular a drop-on-demand print head with bubble jet or piezo technology.

18. The process according to claim 17, wherein the print head is movable at least in one plane under the control of a computer and the nozzles apply at least the binder layer-by-layer.

19. The process according to claim 1, wherein the building material mixture comprises silicon carbide or another sinterable material as building base material and the building structure is sintered.

20. A mold or core producible by the method according to claim 1 for metal casting, in particular iron, steel, copper or aluminum casting.

21. A binder having a viscosity of from 5 to 40 mPas at 25° C. comprising more than 60 wt. % of furfuryl alcohol and from 0.1 wt. % to 12.0 wt. % of at least one novolak.

22. The binder according to claim 21, wherein the binder contains less than 15 wt. %, preferably less than 12 wt. %, and particularly preferably less than 10 wt. % of furan resins.

23. The binder according to claim 21 further characterized by one or more of the following:
the binder comprises more than 75 wt. % of furfuryl alcohol;
the binder comprises 0.1 to 12 wt. % of the novolak;
the novolak is added in solid form to the furfuryl alcohol or the binder and is then dissolved in the binder;
the binder comprises a viscosity modifier, wherein the number average molecular weight of the viscosity modifier is greater than 300 g/mol;
the free phenol content of the novolak is less than 5.0 wt. %;
the binder has a viscosity of from 6 to 30 mPas at 25° C.; and
the binder further comprises phenol, phenol compounds, further resins, water, glycols, alcohols, solvents and/or silanes.

24. A kit comprising the binder according to claim 21 and, separately therefrom, a hardener comprising an acid, wherein the hardener preferably further comprises glycols, in particular ethylene glycol, and/or alcohols, in particular ethanol, preferably in amounts of greater than 0 wt. % to 15 wt. %, based on the hardener.
